(19) United States
(12) Patent Application Publication
(10) Pub. No.: US 2024/0220239 A1
(43) Pub. Date: Jul. 4, 2024

(54) PROGRAM CORRECTING APPARATUS, PROGRAM CORRECTING METHOD AND PROGRAM

(71) Applicant: NIPPON TELEGRAPH AND TELEPHONE CORPORATION, Tokyo (JP)

(72) Inventor: Daisuke YAMAGUCHI, Tokyo (JP)

(21) Appl. No.: 18/558,251

(22) PCT Filed: May 7, 2021
(86) PCT No.: PCT/JP2021/017569

§ 371 Date: Oct. 31, 2023

(51) Int. Cl. G06F 8/76; G06F 8/41

(52) U.S. Cl. CPC G06F 8/76; G06F 8/427

(57) ABSTRACT

A program correction apparatus includes: an analysis unit configured to parse a source code including an API requiring migration and extract types and expressions of first elements constructing calculation after calling of the API; and a specifying unit configured to specify, among the first elements, a portion corresponding to the first element having a type common to one of second elements constructing a difference between source codes of a program before the migration and a program after the migration in a migration instance of the API as a portion requiring rewriting in the source code. Thus, a success rate of migration of the API is improved.

### TECHNICAL FIELD

The present invention relates to a program correction device (program correction apparatus), a program correction method, and a program.

### BACKGROUND ART

If APIs are not recommended or deleted in release of new versions of libraries, migration of the APIs (changes in the APIs to be called) is required for programs (client codes) using the APIs. Users of the libraries can ascertain operations of editing specific codes necessary for migrating the APIs in accordance with migration instances shown in migration guides or the like or techniques enabling the collection of instances. However, if the editing operations are applied to the client codes as they are, the APIs are not migrated.

For example, a migration instance as illustrated in FIG. 1 will be considered. It is assumed that new and old codes can be matched as follow. In FIG. 1, (1) illustrates a program before the migration and (2) illustrates a program after the migration.

The example of FIG. 1 shows a migration instance by deleting or not recommending api( ) that returns a value of a type Rectangle. Since there is api( ) that returns a value of a type Shape (Shape is a higher-order type with respect to Rectangle) as a migration destination, it is shown that a calling portion of api( ) may be replaced with api′( ) as an operation of editing of a code.

However, whether migration is successful in a case in which a program such as anotherCalculation(api( )); is applied depends on calculation after calling of api( ). In anotherCalculation, a value of a Rectangle type is not necessarily required as in someCalculation. When calculation is possible with a value of a Shape type, the migration succeeds. However, when a value of the Rectangle type is required in anotherCalculation, the migration fails. To prevent the migration from failing, it is necessary to apply a code editing operation conforming to calculation after calling of api( ) of a client code.

In the related art, update example analysis has been proposed as a technique for automatically applying an editing operation to a client code (NPL 1). A purpose of the update example analysis is to find an editing operation of a client code commonly executed in any migration instance and apply the editing operation to the client code. Accordingly, a large amount of migration instances are collected, and common portions are extracted for the editing operations.

### CITATION LIST

### Non Patent Literature

NPL 1: Matrix Fazzini, Qi Xin, and Alesandrro Orso, “Automated API-usage update for Android Apps,” In Proceedings of the 28th ACM SIGSOFT International Symposium on Software Testing and Analysis (ISSTA 2019), Association for Computing Machinery, New York, NY, USA 204-215, [Online], Internet <URL: https: //doi.org/10.1145/3293882.3330571>

### SUMMARY OF INVENTION

### Technical Problem

In a method of NPL 1, only an editing operation of a client code executed in common in any migration instance is used. Therefore, the client code is not edited more than necessary. However, even if an editing operation on calculation after calling an API is required, a common portion of the editing operation of a plurality of migration instances is extracted, and an editing operation to be applied to the client code is not executed (migration may fail).

For example, in an instance in which migration is completed only by calling api′( ) without calling getRectangle( ), as in the example illustrated in FIG. 1, despite correcting anotherCalculation(api( ); to anotherCalculation(api′( ).getRectangle( )); in one migration instance, the common portion may be a portion in which api( ) is rewritten as api( ). As a result, the above-described migration may not be prevented from failing.

The present invention has been finalized in view of the foregoing circumstances and an objective of the present invention is to improve a success rate of migration of an API.

### Solution to Problem

Accordingly, to solve the foregoing problem, a program correction device (program correction apparatus) includes: an analysis unit configured to parse a source code including an API requiring migration and extract types and expressions of first elements constructing calculation after calling of the API; and a specifying unit configured to specify, among the first elements, a portion corresponding to the first element having a type common to one of second elements constructing a difference between source codes of a program before the migration and a program after the migration in a migration instance of the API as a portion requiring rewriting in the source code.

### Advantageous Effects of Invention

It is possible to improve a success rate of migration of an API.

### BRIEF DESCRIPTION OF DRAWINGS

FIG. 1 is a diagram illustrating an example of a migration instance.

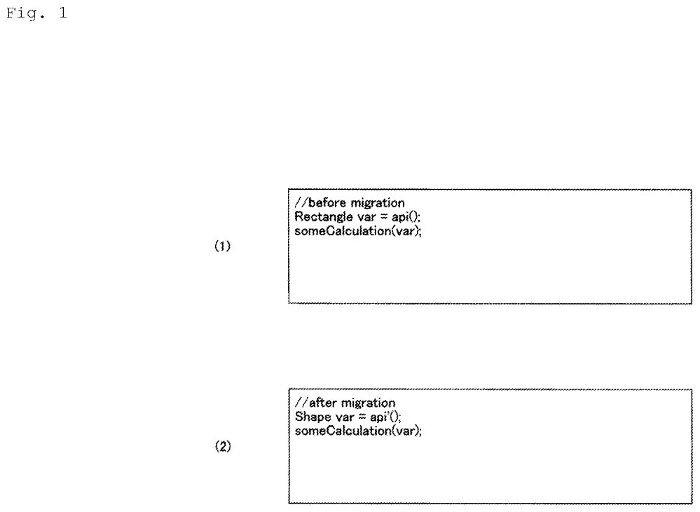

FIG. 2 is a diagram illustrating an exemplary hardware configuration of a program correction device according to an embodiment of the present invention.

FIG. 3 is a diagram illustrating an example of a functional configuration of the program correction device 10 according to the embodiment of the present invention.

FIG. 4 is a flowchart illustrating an example of a processing procedure executed by the program correction device 10.

FIG. 5 is a flowchart illustrating an example of a processing procedure of post-calculation analysis.

FIG. 6 is a diagram illustrating an example of a client code.

FIG. 7 is a diagram illustrating an example of an abstract syntax tree.

FIG. 8 is a flowchart illustrating an example of a processing procedure of post-calculation comparison.

FIG. 9 is a diagram illustrating an example of expected rewriting.

### DESCRIPTION OF EMBODIMENTS

In the present embodiment, a technology for automatically correcting a client code of a correction target by using the collected migration instances is disclosed. In the correction, a program of a type used for post-calculation in which an API is called is reconfigured from a migration instance. That is, when a type of a return value of the API after the migration is changed from a type of a return value of the API before migration, inconsistency of the type occurs between the types of values obtained by calling of the API with regard to a type of a program used in the calculation after calling of the API. In order to eliminate the inconsistency, a program is required to convert the type of the value obtained by calling of the API into the type of the program used for the calculation after calling of the API. The “reconstruction” means such conversion. In the present embodiment, a part of code editing in a migration instance is cut and reflected in the client code to implement the reconstruction. In the present embodiment, since an operation of obtaining a common portion of the collected migration instances is not executed, the number of collected instances does not affect success or failure of the migration.

The client code is a term for distinguishing a source code of a program using an API from a source code of a library providing the API. The migration of the API means a change in the API called by the client code. The term, a part of the client code or a “program” used for a migration instance, means syntax definition of the program. The syntax definition of the program refers to a statement, an expression, and a column of a statement or expressions formed by them, and the statement and the expression each have a recursive structure.

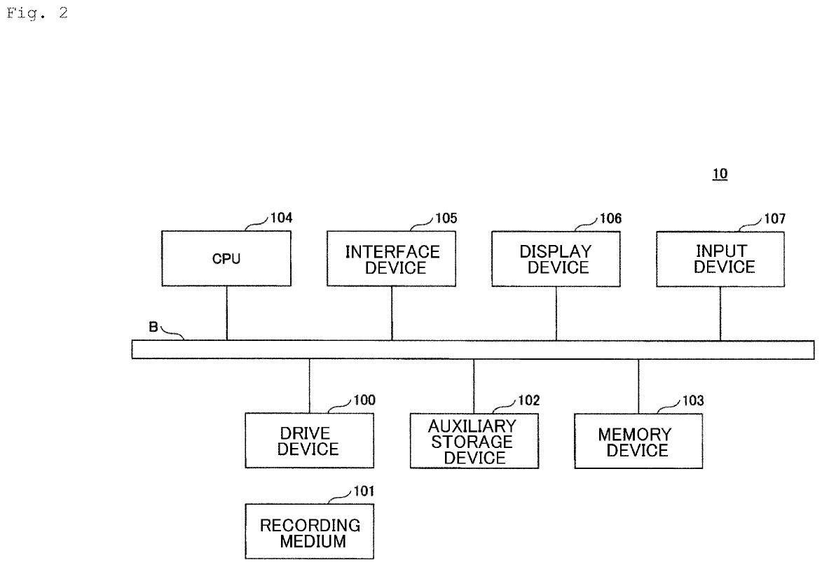

Hereinafter, embodiments of the present invention will be described below with reference to the drawings. FIG. 2 is a diagram illustrating an exemplary hardware configuration of a program correction device 10 (program correction apparatus) in an embodiment of the present invention. The program correction device 10 illustrated in FIG. 2 includes a drive device 100, an auxiliary storage device 102, a memory device 103, a CPU 104, an interface device 105, a display device 106, and an input device 107, which are connected to each other via a bus B.

A program that implements processing executed in the program correction device 10 is provided from a recording medium 101 such as a CD-ROM. When the recording medium 101 storing the program is set in the drive device 100, the program is installed from the recording medium 101 to the auxiliary storage device 102 via the drive device 100. Here, the program does not necessarily have to be installed from the recording medium 101 and may be downloaded from another computer via a network. The auxiliary storage device 102 stores the installed program as well as necessary files, data, and the like.

The memory device 103 reads and stores the program from the auxiliary storage device 102 when an instruction is given to start the program. The CPU 1004 implements a function related to the program correction device 10 in accordance with the program stored in the memory device 103. The interface device 105 is used as an interface for connection to a network. The display device 106 displays a graphical user interface (GUI) or the like in accordance with a program. The input device 107 is configured with a keyboard, a mouse, and the like and is used to input various operation instructions.

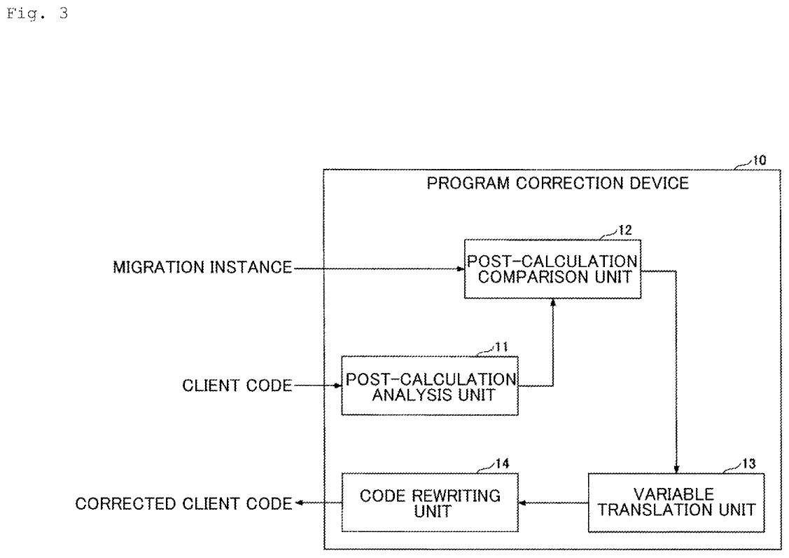

FIG. 3 is a diagram illustrating an example of a functional configuration of the program correction device 10 according to an embodiment of the present invention. As illustrated in FIG. 3, the program correction device 10 includes a post-calculation analysis unit 11, a post-calculation comparison unit 12, a variable translation unit 13, and a code rewriting unit 14. These units are implemented through processing that one or more programs installed in the program correction device 10 cause the CPU 104 to execute.

The post-calculation analysis unit 11 analyzes calculation after calling of an API (hereinafter referred to as “post-calculation”) in a client code of a correction target, constructs a model to be described below (hereinafter referred to as a “post-calculation model”), and extract a type used for the post-calculation of the client code from the client code. The calculation means definition on the client code.

The post-calculation comparison unit 12 compares the post-calculation of each of a plurality of collected migration instances with the post-calculation of the client code, specifies a portion requiring rewriting by the client code, and specifies an element having a type consistent with an element of the post-calculation of the client code (hereinafter referred to as a “common element”) among calculation elements (expressions and types) constructing a difference between before and after migration in a migration instance.

The variable translation unit 13 takes measures for a variable in a code and a variable of the client code with regard to a program after the migration in the migration instance.

The code rewriting unit 14 rewrites the client code using the common element obtained by the post-calculation comparison unit 12.

A data structure of each of an input value and an output value in FIG. 3 and a post-calculation model can be written as follows in a format which is based on a Backus-Naur form (BNF) notation.

[Input value]
<migration instance>: =<program before migration> <program
after migration>
<program before migration>: =<String>
<program after migration>: =<String>
<client code> =<String>
[Output value]
<corrected client code>: =<String>
[Post-calculation model]
<post-calculation>:=(<expression><type>)*

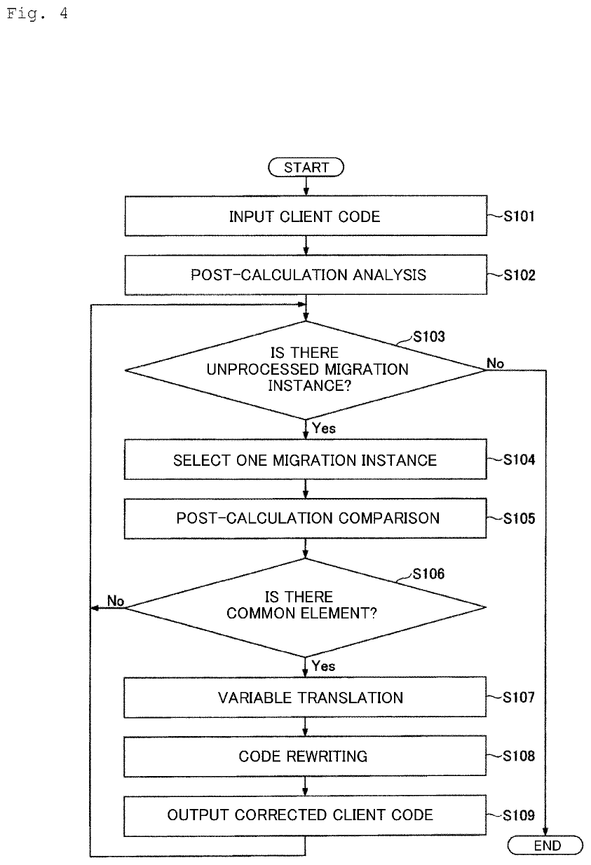

Hereinafter, a processing procedure of the program correction device 10 in FIG. A1 will be described. FIG. 4 is a flowchart illustrating an example of the processing procedure executed by the program correction device 10.

In step S101, the post-calculation analysis unit 11 inputs a client code. The input client code is referred to as an “target client code” below.

Subsequently, the post-calculation analysis unit 11 generates a post-calculation model by executing post-calculation analysis on the target client code (S102). The post-calculation model obtained (extracted) as a result of the post-calculation analysis is a list of expressions and types declared in the post-calculation of the client code, and indicates what type is used for the post-calculation.

Subsequently, the post-calculation comparison unit 12 determines whether there is an unprocessed migration instance among a plurality of input migration instances (S103).

When there is the unprocessed migration instance (Yes in S103), the post-calculation comparison unit 12 selects one migration instance among the unprocessed migration instances as a processing target (hereinafter referred to as a “target instance”) (S104).

Subsequently, the post-calculation comparison unit 12 compares the target instance with the post-calculation model of the client code obtained through the post-calculation analysis to specify a portion requiring rewriting in the target client code and specify a common element between the post-calculation of the target client code and the post-calculation of the target client code in the target instance (S105). When there is no corresponding common element (No in S106), the processing returns to step S103. Accordingly, in this case, code rewriting in which the target instance is used is not executed.

When there is the corresponding common element (Yes in S106), the program correction device 10 reflects the rewriting of the code in accordance with the target instance in the client code in steps S107 and S108.

Specifically, in step S107, the variable translation unit 13 changes the program after the migration by replacing a variable declared by the program after the migration of the target instance (more strictly, a variable in the common element) with a variable declared in the target client code. Such a change is referred to as “variable translation” below.

Subsequently, the code rewriting unit 14 generates the corrected client code by rewriting a copy of the target client code in accordance with the migration instance in which the variable is translated (S108). Such rewriting is implemented by replacing the portion specified in step S105 with a (variable-translated) common element in the target client code.

Subsequently, the code rewriting unit 14 outputs the corrected client code. That is, each corrected client code is generated and output for each migration instance in which it is determined that there is the common element.

Next, details of three types of processing, the post-calculation analysis (S102), the post-calculation comparison (S105), and the variable translation (S107) will be described.

### [Post-Calculation Analysis]

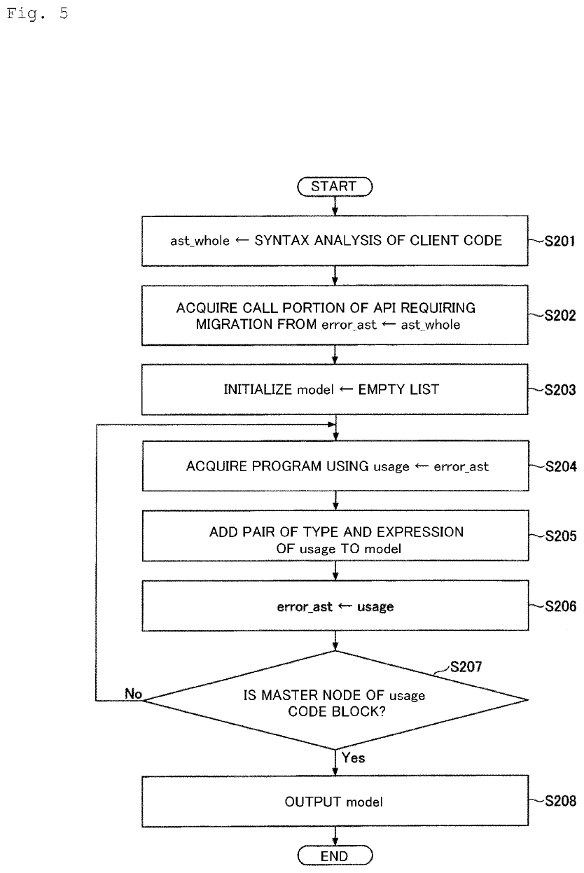

FIG. 5 is a flowchart illustrating an example of the processing procedure of the post-calculation analysis. In the post-calculation analysis, the target client code is accepted as an input and the model of the post-calculation is output.

In step S201, the post-calculation analysis unit 11 executes syntax analysis of the target client code to generate an abstract syntax tree ast_whole.

Subsequently, the post-calculation analysis unit 11 acquires a call portion error_ast of the API requiring migration from the ast_whole (S202). error_ast is a subtree under a node corresponding to the portion in the abstract syntax tree ast_whole. The call portion of the API requiring migration may be specified based on an inspection result at the time of compiling by compiling the client code or specified in accordance with another method. In FIG. 5, the processing procedure will be described based on the assumption that the number of portions is one. When the number of portions is plural, steps subsequent to step S202 may be executed on the plurality of portions.

Subsequently, the post-calculation analysis unit 11 initializes a model which is a variable in a list type to an empty state (S203).

Subsequently, the post-calculation analysis unit 11 acquires a program usage using error_ast from a code block including error_ast in the target client code (S204). The code block means a range surrounded by parentheses. The “program using error_ast” is a program using a result obtained by calling the “API requiring migration.” When a master node of the error_ast matches any of the followings, the post-calculation analysis unit 11 acquires the master node as a program using error_ast.
return statement
method call
field access
constructor call
assignment statement

The method call is not an API call but any method call. The field access is a reference to a field having a value of a certain data type. For example, in the case of C language, a pointer to a member of a structure corresponds to field access.

Subsequently, the post-calculation analysis unit 11 adds a pair of type and expression of the usage as one element to the model (S205). Subsequently, the post-calculation analysis unit 11 sets the usage as a new error_ast (S206). That is, the node indicated by the error_ast moves to a root node side in ast_whole. Here, when the usage is an assignment statement, the post-calculation analysis unit 11 exceptionally sets a node corresponding to an assignment destination in the assignment statement as a new error_ast.

Subsequently, the post-calculation analysis unit 11 determines whether the master node of the usage (a master node of a root node of a subtree usage) in ast_whole is a code block (S207). For example, when a usage in a program such as {return g (f (x));} is return g(f(x)); (where an abstract syntax tree is converted actually), the master node of the usage becomes {return g(f(x));}. Therefore, in this case, the master node of the usage corresponds to a code block.

When the master node is not the code block (No in S207), the post-calculation analysis unit 11 repeats steps subsequent to step S204. When the master node is the code block (Yes in S207), the post-calculation analysis unit 11 outputs a model as a model of post-calculation (S208). Finally, a list of programs recursively using error_ast is obtained in model.

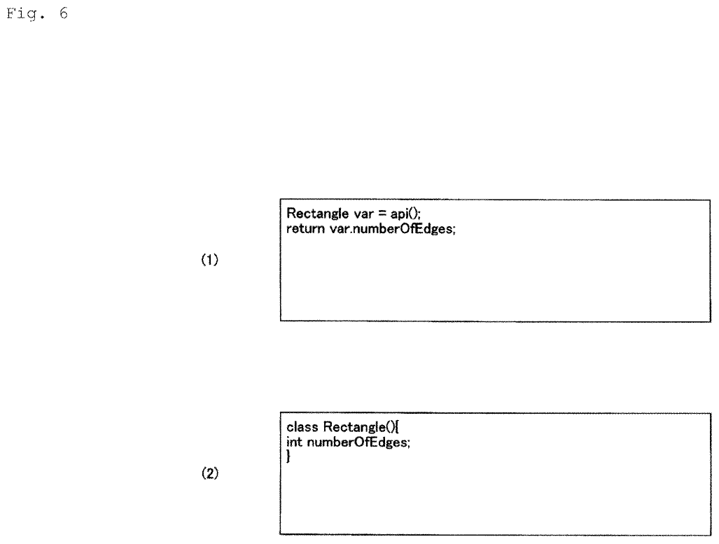

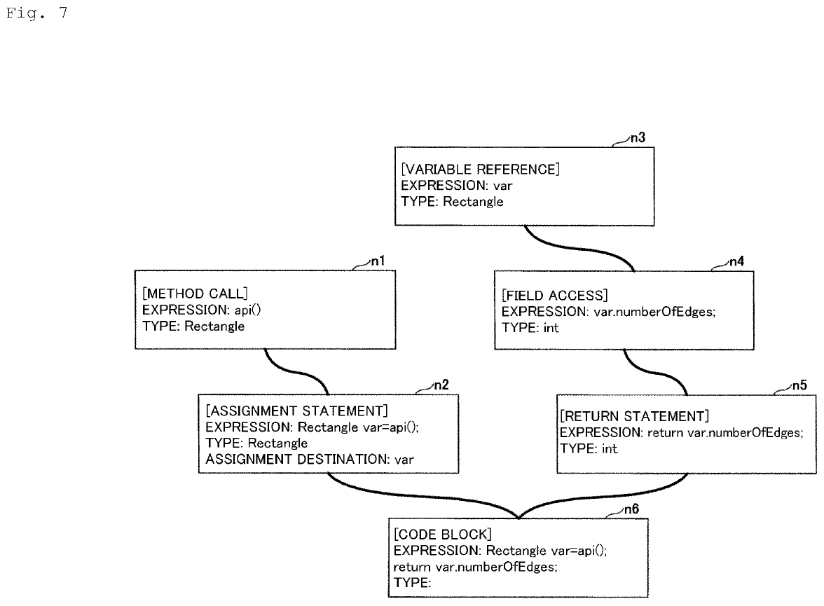

For example, if a part of the target client code is as illustrated (1) of FIG. 6, an abstract syntax tree as illustrated in FIG. 7 is generated in step S201. Here, in the client code, class definition shown in (2) of FIG. 6 is made within the scope of var.numberOfEdges.

Here, if api( ) is an API requiring migration, a node n1 in FIG. 7 is acquired as error_ast in step S202.

In step S204, a node n2 in FIG. 7 is acquired as a usage. This is because the node n2 corresponds to an assignment statement. Accordingly, in step S205, (Rectangle, var) which is an expression and a type of the node n2 is added to the model.

In step S206, since the usage is an assignment statement, a node n3 which is a node of an assignment destination of the node n2 is considered to be new error_ast in FIG. 7.

In step S204 of the second round executed for new error_ast, a node n4 in FIG. 7 is acquired as a usage. This is because the node n4 corresponds to the field access. Accordingly, in step S205 of the second round, the expression and type of the node n4 (int, var.numberOfEdges) are added to the model. As a result, the model becomes [(Rectangle, var), (int, var.numberOfEdges)].

In step S206 of the second round, the node n4 is considered to be new error_ast.

In step S204 of the third round, a node n5 of FIG. 7 is acquired as a usage. This is because the node n5 corresponds to a return statement. Accordingly, in step S205 of the third round, the expression and type of the node n5 (int, var.numberOfEdges) are added to the model. However, since the same element is already in the model, overwriting can be executed merely. Therefore, the content of the model is not changed.

In step S206 of the third round, the node n5 is considered to be new error_ast.

Since the master node of the user (node n5) is a code block in step S207 of the third round, [(Rectangle, var), (int, var.numberOfEdges)] which is content of the model at this time point is output in step S208.

### [Post-Calculation Comparison]

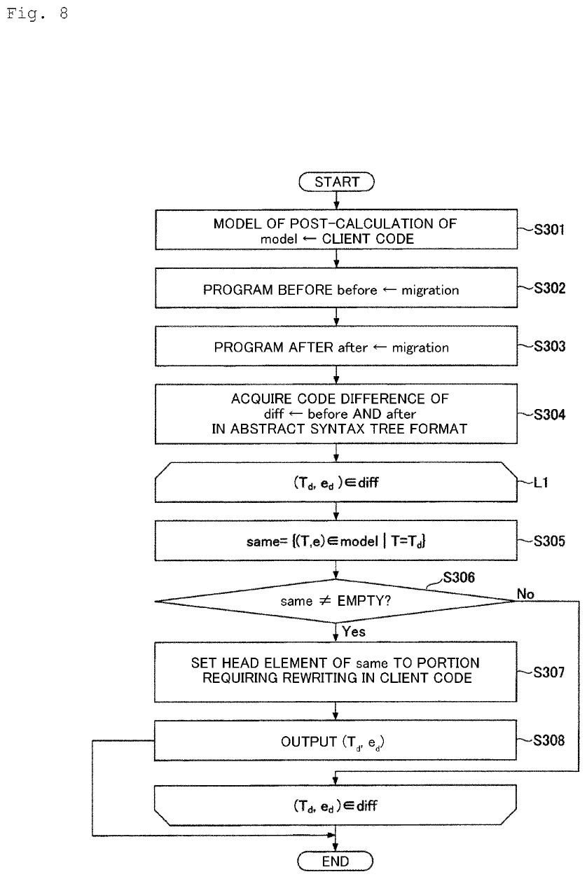

FIG. 8 is a flowchart illustrating an example of the processing procedure of post-calculation comparison. In the post-calculation comparison, a model of post-calculation of the target client code and the target instance are accepted as an input, a portion requiring rewriting with the client code is specified and a common element with the target client code in the target instance is specified.

In step S301, the post-calculation comparison unit 12 acquires a model of post-calculation of the target client code. Subsequently, the post-calculation comparison unit 12 acquires a “program before” before migration from the target instance (S302). Subsequently, the post-calculation comparison unit 12 acquires a “program after” after migration from the target instance (S303). Subsequently, the post-calculation comparison unit 12 acquires a code difference ((difference portion) of after to before) diff between before and after in an abstract syntax tree format (S304).

The code difference in the abstract syntax tree format can be obtained using the Update sample analysis of NPL 1. For example, in the migration instance, the code difference in the abstract syntax tree format when rewriting calc(api( )) to calc(api′( ).getRectangle( )) is as follows.

[(T, calc(api′ ( ). getRectangle( ))),
[(Rectangle, api′ ( ). getRectangle( )),
[(Shape, api′ ( ))]
]
]

Subsequently, the post-calculation comparison unit 12 executes loop processing L1 for each node (T_{d}, e_{d}) of diff.

Hereinafter, a node which is a processing target in the loop processing L1 is referred to as a “target node.” The target node is selected in a descending order from the root element of diff. T_{d} indicates a type of the target node and e_{d} indicates an expression of the target node.

Subsequently, the post-calculation comparison unit 12 assigns an element including the same type as the type T_{d} of the target node in the model in a list same (S305).

Subsequently, the post-calculation comparison unit 12 determines whether the sane is empty (S306). When the sample is empty (No in S306), steps subsequent to step S307 are not executed on the target node.

When the sample is not empty (when an element including the same type as the type T_{d} of the target node is retrieved) (Yes in S306), a head element of the same is specified as a portion requiring rewriting to a client code in step S108 of FIG. 4 (S307). That is, in step S108, a portion corresponding to the head element is rewritten.

Only the head element is set as a portion requiring rewriting based on the fact that the order of the elements of the sample and the order of the elements of the model are common. In the model generated by the post-calculation analysis, the order of the elements is in an order of a depth direction of the abstract syntax tree from a “call portion of the API requiring migration.” That is, when there are two elements a and b adjacent in the model, b is a slave node of a in a positional relation between a and b on the abstract syntax tree. This is because, when it is preferably considered that this order is also common in the same and a range to be rewritten is as small as possible, it is rational to say that elements other than the head element are neglected despite a plurality of elements of the same and only the head element is set as the “portion requiring rewriting to the client code.

Subsequently, the post-calculation comparison unit 12 outputs (T_{d}, e_{d}) as a common element with the target client code with regard to the target instance (S308) and the processing of FIG. 8 ends. The reason that there is a possibility of slipping in the middle of a loop is that one common element may be found out. (T_{d}, e_{d}) corresponds to an element closest to the “call portion of the API requiring migration” in a positional relation of the depth direction of diff. In this way, in the closest element, inconsistency of the type is eliminated.

For example, when the model of the post-calculation of the client code is [(Rectangle, var), (int, var.numberOfEdges)] and a code difference of the abstract syntax tree format is the above-described example, the same is empty in the first loop. In the second loop, (Rectangle, var) ∈model is consistent with a type Rectangle of (Rectangle, api′( ). getRectangle( )) of a code difference in the abstract syntax tree format. Accordingly, the same becomes [(Rectangle, var)]. Since the same is not empty, the portion requiring rewriting to the client code is set as (Rectangle, var) and slipping (Rectangle, api′( ).getRectangle( )) from the looping processing is output as a common element of a type configured from a migration instance and a type used for post-calculation of the client code.

According to the foregoing structure, in the migration instance, the followings are added:
(1) replacement with a call of a new method called api′( ); and
(2) a method call such as getRectangle( ) using a call result, Such two types of editing are executed. It is determined whether both (1) and (2) are included or only (1) is included in accordance with the post-calculation (in this example, a value of Rectangle is necessary) of the client code.

The result is seen in addition of editing for adding a method call called getRectangle( ) from the code editing of the migration instance to code editing reflected in the client code. In the related art, api( ) is replace with api′( ), a value of the Rectangle type is replaced with a value of a Shape type of a return value of api′( ), and the value of Rectangle type is lost. However, the value of the Rectangle type is reconstructed by applying editing for adding a method call called “getRectangle( ).

### [Variable Translation]

When access to a variable is required to actually configure a type used in the migration instance, it is necessary to declare the variable in the client code as well.

However, the present invention is not limited to the case in which the variable has already been declared in the client code. At this time, when the variables accessed in the migration instance correspond to the variables declared in the client code, the variables which have already been declared can be used. This correspondence is made in accordance with a method in which a variable table storing pairs of variables and types as in NPL 1 is used or a method using a Coccinelle4J (“Kang, H. J., Thung, F., Lawall, J., Muller, G., Jiang, L., & Lo, D. (2019). Semantic patches for Java program transformation (experience report). In 33rd European Conference on Object-Oriented programming (ECOOP 2019). Schloss Dagstuhl-Leibnizi-Zentrum fuer Informatik”).

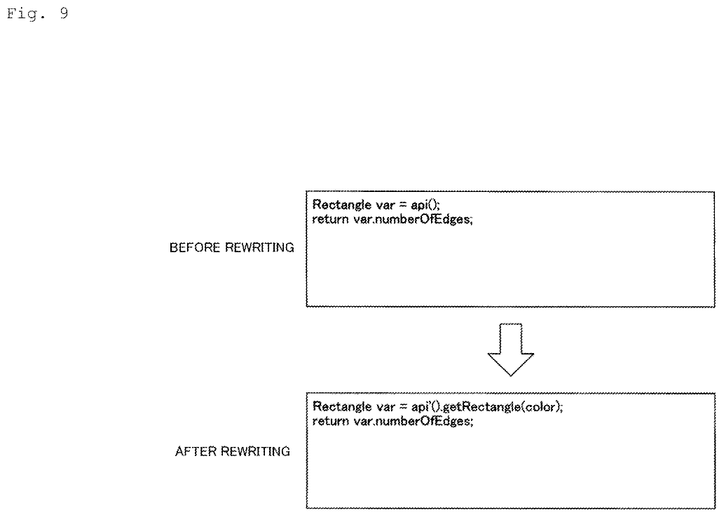

That is, in a stage in which the elements of the editing executed in the migration instance to be reflected in the client code are determined, the editing is editing in another program from the client code. Therefore, when code editing of another program is reflected, inconsistent or same types of variables which are defined in one of programs and are undefined in the other program between variables of the programs are defined in both the programs, but there are different variable names. Description will be made on the assumption that getRectangle in the example described in the post-calculation comparison takes a color of a figure in an argument. In a case in which calc(api( )) is corrected to calc(api′( ).getRectangle(color)) in the migration instance, rewriting of the client code as illustrated in FIG. 9 is expected.

Since a variable “color” is not always defined somewhere in the client code, it is necessary to newly declare color in the client code. Accordingly, in this case, the variable translation unit 13 adds a new declaration to the program after migration of the target instance.

The “correspondence between the variable accessed in the migration instance and the variable declared by the client code is made” is processing executed when “the same type of variables are defined in both programs but the variable names are different.” In the processing, a set of variables defined by the client code is compared with a variable required to be newly defined (color in the previous example), and a variable which can be determined to be the same as a variable in a certain standard is taken out from the set of variables defined in the client code. The certain standard differs depending on a method of translating a variable. For example, in NPL 1, a standard in which the same types of variables are regarded as the same variables is adopted.

As described above, according to the present embodiment, migration for the client code is executed based on the migration instance in which there is a common element with the post-calculation of the client code. Accordingly, it is possible to improve a success rate of the migration of the API.

The post-calculation analysis unit 11 specifies a type used for the post-calculation of the client code. The post-calculation comparison unit 12 configures a value of a type used for the post-calculation of the client code from the type used in the migration instance. Therefore, it is possible to reflect the editing of the code required for calculation after calling of the API in the client code.

In the present embodiments, the post-calculation analysis unit 11 is an example of an analysis unit. The post-calculation comparison unit 12 is an example of a specifying unit. The variable translation unit 13 is an example of a translation unit. The code rewriting unit 14 is an example of a rewriting unit.

Although the embodiments of the present invention have been described in detail above, the present invention is not limited to these particular embodiments, and various modifications and changes can be made within the scope of the gist of the present invention described in the claims.

### REFERENCE SIGNS LIST

10 Program correction device (program correction apparatus)
11 Post-calculation analysis unit
12 Post-calculation comparison unit
13 Variable translation unit
14 Code rewriting unit
100 Drive device
101 Recording medium
102 Auxiliary storage device
103 Memory device
104 CPU
105 Interface device
B Bus

1. A program correction apparatus comprising:
a processor; and
a memory that includes instructions, which when executed, cause the processor to execute a method, said method including:
parsing a source code including an API requiring migration and extract types and expressions of first elements constructing calculation after calling of the API; and
specifying, among the first elements, a portion corresponding to the first element having a type common to one of second elements constructing a difference between source codes of a program before the migration and a program after the migration in a migration instance of the API as a portion requiring rewriting in the source code.

2. The program correction apparatus according to claim 1, wherein the method further includes:
rewriting an expression of the portion requiring the rewriting to an expression of the second element.

3. The program correction apparatus according to claim 1, wherein the method further includes:
replacing a variable declared in the second element with a variable predeclared in the source code.

4. The program correction apparatus according to claim 1, wherein the specifying includes selecting elements of an abstract syntax tree in a descending order from root elements of the abstract syntax tree related to the difference, and specifying a portion closest to a call portion of the API as the portion requiring the rewriting in the retrieved first element when the first element having the type common to the selected element is retrieved.

5. A program correction method causing a computer to execute:
parsing a source code including an API requiring migration and extracting types and expressions of first elements constructing calculation after calling of the API; and
specifying, among the first elements, a portion corresponding to the first element having a type common to one of second elements constructing a difference between source codes of a program before the migration and a program after the migration in a migration instance of the API as a portion requiring rewriting in the source code.

6. A non-transitory computer-readable recording medium having computer-readable instructions stored thereon, which when executed cause a computer including a memory and a processor to execute the method according to claim 1.
